(19) United States
(12) Patent Application Publication
(10) Pub. No.: US 2020/0324900 A1
(43) Pub. Date: Oct. 15, 2020

(54) UNMANNED AERIAL VEHICLE AND CONTROL METHOD FOR UNMANNED AERIAL VEHICLE

(71) Applicant: SZ DJI TECHNOLOGY CO., LTD., Shenzhen (CN)

(72) Inventor: Liang SONG, Shenzhen (CN)

(21) Appl. No.: 16/908,390

(22) Filed: Jun. 22, 2020

Related U.S. Application Data
(63) Continuation of application No. PCT/CN2017/117976, filed on Dec. 22, 2017.

(51) Int. Cl. B64C 39/02; B64C 29/00; B64D 41/00; B64D 47/08

(52) U.S. Cl. CPC B64C 39/024; B64C 29/0033; B64D 41/00; B64C 2201/127; B64C 2201/021; B64C 2201/108; B64D 47/08

(57) ABSTRACT

An unmanned aerial vehicle (UAV) includes a main frame, a pair of front wings, a pair of rear wings, and a plurality of rotor power assemblies. The pair of front wings are arranged at two opposite sides of the main frame and configured to rotate relative to the main frame about a first rotation axis perpendicular to a front-rear direction of the main frame. The pair of rear wings are arranged at the two opposite sides of the main frame and are closer to a rear end of the main frame than the pair of front wings. The pair of rear wings are configured to rotate relative to the main frame about a second rotation axis perpendicular to the front-rear direction of the main frame. The plurality of rotor power assemblies are mounted at the front wings and the rear wings.

### CROSS-REFERENCE TO RELATED APPLICATION

This application is a continuation of International Application No. PCT/CN2017/117976, filed Dec. 22, 2017, the entire content of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the aircraft technology field and, more particularly, to an unmanned aerial vehicle (UAV) and a UAV control method.

### BACKGROUND

An unmanned aerial vehicle is an unmanned aircraft that is operated by a wireless electrical controller or a remote controller to perform a mission. In recent years, UAV has been developed and applied in a plurality of fields, such as civil application, industrial application, military application, etc. A conventional rotor UAV rotates rotor power assemblies for the UAV to fly. However, the rotor UAV always has deficiencies, such as low energy efficiency, low flight speed, etc.

### SUMMARY

In embodiments of the present disclosure, there is provided an unmanned aerial vehicle (UAV) including a main frame, a pair of front wings, a pair of rear wings, and a plurality of rotor power assemblies. The pair of front wings are arranged at two opposite sides of the main frame and configured to rotate relative to the main frame about a first rotation axis perpendicular to a front-rear direction of the main frame. The pair of rear wings are arranged at the two opposite sides of the main frame and are closer to a rear end of the main frame than the pair of front wings. The pair of rear wings are configured to rotate relative to the main frame about a second rotation axis perpendicular to the front-rear direction of the main frame. The plurality of rotor power assemblies are mounted at the front wings and the rear wings.

### BRIEF DESCRIPTION OF THE DRAWINGS

FIG. 1 illustrates a schematic 3D diagram of an unmanned aerial vehicle (UAV) according to some embodiments of the present disclosure.

FIG. 2 illustrates a schematic diagram showing an attitude of the UAV shown in FIG. 1 during taking off and landing according to some embodiments of the present disclosure.

FIG. 3 illustrates a schematic diagram showing an attitude of the UAV shown in FIG. 1 that flies forward in a multi-rotor mode according to some embodiments of the present disclosure.

FIG. 4 illustrates a schematic diagram showing an attitude of the UAV shown in FIG. 1 that flies to the left and right in the multi-rotor mode according to some embodiments of the present disclosure.

FIG. 5 illustrates a schematic diagram showing an attitude of the UAV shown in FIG. 1 when a shooting angle of a camera needs to be increased in the multi-rotor mode according to some embodiments of the present disclosure.

FIG. 6 illustrates a schematic diagram showing an attitude of the UAV shown in FIG. 1 in a high-speed flight mode according to some embodiments of the present disclosure.

FIG. 7 illustrates a schematic diagram showing another attitude of the UAV shown in FIG. 1 in the high-speed flight mode according to some embodiments of the present disclosure.

FIG. 8 illustrates a schematic diagram of the UAV shown in FIG. 7 from another angle according to some embodiments of the present disclosure.

FIG. 9 illustrates a schematic diagram showing another attitude of the UAV shown in FIG. 1 that flies backward in the high-speed flight mode according to some embodiments of the present disclosure.

### DETAILED DESCRIPTION OF THE EMBODIMENTS

In embodiments of the present disclosure, technical solutions are described in conjunction with drawings. The described embodiments are only some embodiments not all the embodiments of the present disclosure. Based on embodiments of the disclosure, all other embodiments obtained by those of ordinary skill in the art without any creative work are within the scope of the present disclosure.

Exemplary embodiments are described in detail, examples of which are shown in the drawings. When the following description below refers to the drawings, unless otherwise indicated, same numerals in different drawings represent the same or similar elements. Implementations described in the following exemplary embodiments do not represent all implementations consistent with the present disclosure. On the contrary, the following described implementations are only examples of devices and methods consistent with some aspects of the present disclosure.

Terms used in the present disclosure describe merely specific embodiments but are not intended to limit the present disclosure. The singular forms of “a,” “said,” and “the” used in the present disclosure and the appended claims are also intended to include plural forms unless the context indicates other meanings. The term “and/or” used in the present disclosure refers to and includes any or all possible combinations of one or more associated listed items. Unless otherwise indicated, similar words such as “front,” “rear,” “lower,” and/or “upper” are used to facilitate the description only and are not limited to one location or one spatial orientation. Similar words such as “connect” and “coupled” are not limited to physical or mechanical connections, and may include electrical connections, whether direct or indirect.

An unmanned aerial vehicle (UAV) of embodiments of the present disclosure includes a main frame, a pair of front wings, a pair of rear wings, and a plurality of rotor power assemblies. The pair of front wings are arranged at two opposite sides of the main frame and may be turned in a front-rear direction relative to the main frame, i.e., be turned relative to the main frame about a rotation axis (first rotation axis) perpendicular to the front-rear direction of the main frame. The pair of rear wings are arranged at two opposite sides of the main frame and are closer to a rear end of the main frame than the pair of front wings. The pair of rear wings may be turned in the front-rear direction relative to the main frame, i.e., be turned relative to the main frame about a rotation axis (second rotation axis) perpendicular to the front-rear direction of the main frame. The plurality of rotor power assemblies are mounted at the front and rear wings. The UAV of the present disclosure includes the pair of front wings and the pair of rear wings that can be turned in the front-rear direction relative to the main frame, and the plurality of rotor power assemblies. The UAV can fly under different attitudes through the rotor power assemblies, the front wings, and the rear wings. Under some attitudes, the UAV can fly at a high speed to improve energy efficiency and flight speed.

In some embodiments, the UAV control method is used to control the UAV. The UAV includes the main frame, the pair of front wings, the pair of rear wings, and the plurality of rotor power assemblies. The pair of front wings are arranged at the two opposite sides of the main frame. The pair of rear wings are arranged at the two opposite sides of the main frame and are close to the rear end of the main frame relative to the pair of front wings. The plurality of rotor power assemblies are mounted at the front and rear wings. The UAV control method includes the following processes. The front and rear wings are controlled to turn in the front-rear direction relative to the main frame. The rotor power assemblies are controlled to rotate. The UAV control method can control the rotor power assemblies, the front wings, and the rear wings to achieve the flight under different attitudes of the UAV. Under some attitudes, the UAV can fly at a high speed to improve the energy efficiency and the flight speed.

In the present disclosure, the UAV and the UAV control method are described in detail in connection with the drawings. Features of following embodiments and implementations may be combined.

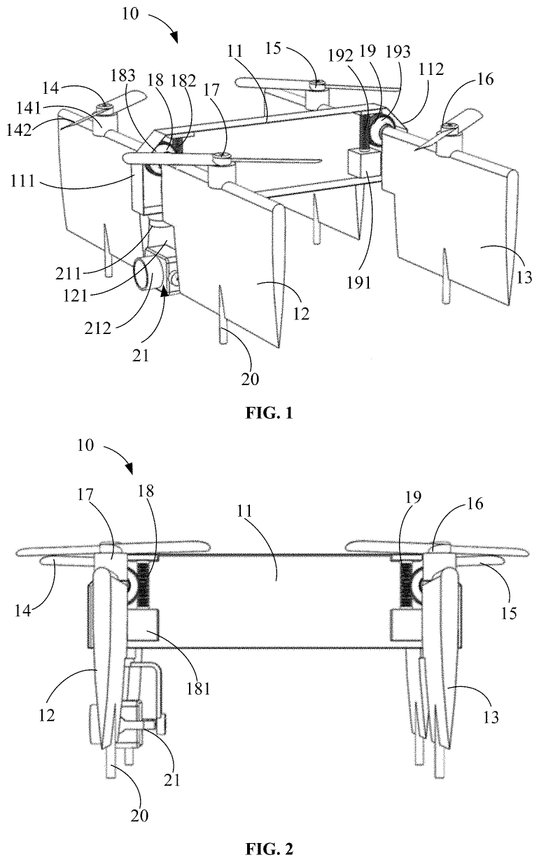

FIG. 1 illustrates a schematic three-dimensional (3D) diagram of a UAV 10 according to some embodiments of the present disclosure. The UAV 10 shown in FIG. 1 is configured for aerial photography, mapping, monitoring, but is not limited to these applications. In some embodiments, the UAV 10 is further configured for agricultural application, express delivery, providing network services, etc. In some embodiments, the UAV 10 includes a main frame 11, a pair of front wings 12, a pair of rear wings 13, and a plurality of rotor power assemblies 14, 15, 16, and 17.

In some embodiments, the main frame 11 may be referred to as a center frame or a center body. In FIG. 1, the main frame 11 is rectangular and includes a front end 111 and a rear end 112 opposite to the front end 111. The front end 11 is a head of the UAV 10. The rear end 112 is a tail of the UAV 10. In FIG. 1, the main frame 11 has a flat shape with a left-right width smaller than a height thereof. In some other embodiments, the main frame 11 may have another shape, for example, the main frame 11 has a generally flat shape with a left-right width greater than the height thereof.

The pair of front wings 12 are arranged at the two opposite sides of the main frame 11 and can be turned in the front-rear direction relative to the main frame 11. In FIG. 1, the front wings 12 are mounted at the front end of the main frame 11. The front wings 12 are symmetrically arranged at the right and left sides of the main frame 11. The two front wings 12 have the same shape. In FIG. 1, the front wing 12 has a plate shape, and the thickness of the front wing 12 gradually reduces from an upper end of the front wing 12 to a lower end of the front wing 12. An upper side edge and a lower side edge of the front wing 12 are substantially perpendicular to the main frame 11, e.g., perpendicular to the front-rear direction of the main frame 11. An outer side surface of the front wing 12 away from the main frame 11 is substantially perpendicular to the upper side edge of the front wing 12. An inner side surface of the front wing 12 near the main frame 11 has a step surface. The lower inner side surface of the front wing 12 is further to the main frame 11 than the upper inner side surface. An opening 121 is formed between lower parts of the pair of front wings 12. In some other embodiments, the front wing 12 may have another shape and is not limited to the shape shown in the figure.

The pair of front wings 12 can be turned backward relative to the main frame 11 or turned forward relative to the main frame 11. The pair of front wings 12 can be turned simultaneously, with the same turning direction and angle. The pair of front wings 12 are always kept symmetrical to each other about the main frame 11. In some embodiments, the pair of front wings 12 are formed separately and mounted individually at the main frame 11. In some other embodiments, the pair of front wings 12 are formed integrally and mounted together at the main frame 11.

The pair of rear wings 13 are arranged at the two opposite sides of the main frame 11 and are close to the rear end of the main frame 11 relative to the pair of front wings 12. The pair of rear wings 13 can be turned in the front-rear direction relative to the main frame 11. In FIG. 1, the rear wings 13 are mounted at the rear end of the main frame 11. In some embodiments, a distance from a connection between the front wing 12 and the main frame 11 to a connection between the rear wing 13 and the main frame 11 is greater than distances from the upper side edges to the lower side edges of the front wing 12 and the rear wing 13. The rear wings 13 are arranged symmetrically at the right and left sides of the main frame 11. The two rear wings 13 have the same shape. In FIG. 1, the rear wings 13 have the same shape as the front wings 12, which is not repeated here. In some other embodiments, the rear wings 13 may have another shape.

Similar to the front wings 12, the pair of rear wings 13 can be turned backward relative to the main frame 11 or forward relative to the main frame 11. The pair of rear wings 13 can be turned simultaneously, with the same turning direction and angle. The pair of rear wings 13 are always kept symmetrical to each other about the main frame 11. In some embodiments, the pair of rear wings 13 are formed separately and mounted individually at the main frame 11. In some other embodiments, the pair of rear wings 13 are formed integrally and mounted together at the main frame 11.

The UAV 10 includes a front wing drive assembly 18 and a rear wing drive assembly 19 arranged at the main frame 11. The front wing drive assembly 18 is connected to the front wing 12 and is configured to drive the front wing 12 to turn in the front-rear direction relative to the main frame 11. The rear wing drive assembly 19 is connected to the rear wing 13 and is configured to drive the rear wing 13 to turn in the front-rear direction relative to the main frame 11.

In some embodiments, the front wing drive assembly 18 includes a front electric motor 181 (as shown in FIG. 2), a front screw 182 connected to the front electric motor 181, and a front gear 183 meshed with the front screw 182. The front gear 183 is connected to the front wing 12. The upper end of the front wing 12 is fixedly connected to the center of the front gear 183. The front electric motor 181 drives the front screw 182 to rotate to drive the front gear 183 to rotate. As such, the front wing 12 is driven to turn. Similar to the front wing drive assembly 18, the rear wing drive assembly 19 includes a rear electric motor 191, a rear screw 192 connected to the rear electric motor 191, and a rear gear 193 meshed with the rear screw 192. The rear gear 193 is connected to the rear wing 13. The rear electric motor 191 drives the rear screw 192 to rotate to drive the rear gear 193 to rotate. As such, the rear wing 13 is driven to turn. The screws 182 and 192, and the gears 183 and 193 can resist the wind when the UAV 10 takes off. As shown in FIG. 1, the front screw 182 is located behind the front gear 183, and the rear screw 192 is located behind the rear gear 193.

In some other embodiments, the front wing 12 is directly connected to the rotation shaft of the front electric motor 181. The rotation shaft of the front electric motor 181 rotates to drive the front wing 12 to turn. The rear wing 13 is directly connected to the rotation shaft of the rear electric motor 191. The rotation shaft of the rear electric motor 191 rotates to drive the gear wing 13 to turn.

In some embodiments, each of the front wing drive assembly 18 and the rear wing drive assembly 19 includes two electric motors rotating in opposite directions. That is, the front wing drive assembly 18 includes two front electric motors rotating in opposite directions, and the rear wing drive assembly 19 includes two rear electric motors rotating in opposite directions. One of the front electric motors 181 drives the front wing 12 to turn forward. The other one of the front electric motors 181 drives the front wing 12 to turn backward. Similarly, one of the rear electric motors 191 drives the rear wing 13 to turn forward. The other one of the rear electric motors 191 drives the rear wing 13 to turn backward.

In some other embodiments, each of the front wing drive assembly 18 and the rear wing drive assembly 19 includes an electric motor that can rotate forward and backward. That is, the electric motor 181 may rotate forward and backward to drive the front wing 12 to turn forward or backward. The rear electric motor 191 may rotate forward and backward to drive the front wing 13 to turn forward or backward.

The above-described embodiments are merely examples of the front wing drive assembly 18 and the rear wing drive assembly 19. In some other embodiments, the front wing drive assembly 18 and the rear wing drive assembly 19 may include other elements or structures, which can drive the front wing 12 and the rear wing 13 to turn.

The plurality of rotor power assemblies 14-17 are mounted at the front wings 12 and the rear wings 13. In some embodiments, the plurality of rotor power assemblies 14-17 include the same structure and shape. For example, the rotor power assembly 14 includes a rotor electric motor 141 and a rotor 141 mounted at the rotor electric motor 141. The rotor electric motor 141 drives the rotor 142 to rotate. In some embodiments, the rotor 142 includes two blades but is not limited to this. In some other embodiments, the rotor 142 may include three or more blades.

The plurality of rotor power assemblies 14, 15, 16, and 17 (also referred to as rotor power assemblies 14-17) include the pair of front rotor power assemblies 14 and 17 and the pair of rear rotor power assemblies 15 and 16. The pair of front rotor power assemblies 14 and 17 are symmetrically mounted at the pair of front wings 12 about the main frame 11. The pair of rear rotor power assemblies 15 and 16 are symmetrically mounted at the pair of rear wings 13 about the main frame 11. In some embodiments, the front rotor power assemblies 14 and 17 are mounted at middle positions of the upper side edges of the front wings 12, and the rear rotor power assemblies 15 and 16 are mounted at middle positions of the upper side edge of the rear wings 13. In some embodiments, a distance from the front rotor power assembly 14 or 17 to the main frame 11 is equal to a distance from the rear rotor power assembly 15 or 16 to the main frame 11. In FIG. 1, rotation planes of the rotor power assemblies 14-17 are perpendicular to the front wings 12 and the rear wings 13. That is, the rotation planes of the rotors of the rotor power assemblies 14-17 are perpendicular to the front wings 12 and the rear wings 13.

The UAV 10 includes a plurality of stands 20. The plurality of stands 20 are arranged at the lower parts of the front wings 12 and the rear wings 13 and extend downward beyond the lower side edges of the front wings 12 and the rear wings 13. The stands 20 provide support and cushion functions for the UAV during taking off and landing, which can avoid the front wings 12, the rear wings 13, the main frame 11, a load of the UAV 10, or other components from being damaged by directly hitting the ground. In some embodiments, one pair of stands 20 arranged at the lower parts of the pair of front wings 12 are symmetrical about the main frame 11, and one pair of stands 20 at the lower parts of rear wings 13 are symmetrical about the main frame 11. In some embodiments, a distance from a stand 20 arranged at the lower part of a front wing 12 to the main frame 11 is equal to a distance from a stand 20 arranged at the lower part of a rear wing 12 to the main frame 11.

In some embodiments, the stands 20 are located directly under the corresponding rotor power assemblies 14-17, and center axes of the stands 20 are in line with the corresponding center axes of the rotor power assemblies 14-17. In some other embodiments, the stands 20 may be arranged at other positions under the front wings 12 and the rear wings 13. In some embodiments, the stands 20 are generally cylindrical but are not limited to this. In some other embodiments, the stands 20 may have other shapes.

The UAV 10 includes a load 21 mounted at the front end of the main frame 11. The load 21 is located between the pair of front wings 12. In some embodiments, the load 21 includes a gimbal 211 mounted at the main frame 11 and a camera 212 mounted at the gimbal 211. When the front wings 12 are perpendicular to the main frame 11, e.g., perpendicular to the front-rear direction of the main frame 11, the gimbal 211 is located in an opening 121 formed between the pair of front wings 12. The whole or part of the camera 212 is located in the opening 121.

FIG. 2 illustrates a schematic diagram showing an attitude of the UAV 10 shown in FIG. 1 during taking off and landing according to some embodiments of the present disclosure. When the UAV 10 takes off or lands, the front wings 12 and the rear wings 13 are perpendicular to the main frame 11, e.g., perpendicular to the front-rear direction of the main frame 11. In FIG. 2, the front wings 12 and the rear wings 13 are perpendicular to an upper side edge of the main frame 11. When the main frame 11 is arranged horizontally, the front wings 12 and the rear wings 13 extend vertically, and the rotation planes of the rotor power assemblies 14-17 are parallel to the horizontal plane. The front wing drive assembly 18 drives the front wings 12 to be perpendicular to the main frame 11, e.g., perpendicular to the front-rear direction of the main frame 11. The rear wing drive assembly 19 drives the rear wings 13 to be perpendicular to the main frame 11, e.g., perpendicular to the front-rear direction of the main frame 11. Lower ends of the stands 20 are lower than a lower end of the load 21, such that the stands 20 protect the load 21. During taking off and landing in the multi-rotor mode, the UAV 10 takes off and lands vertically, such that a small field is needed for taking off and landing.

When the UAV 10 is in flight in the multi-rotor mode, the front wings 12 and the rear wings 13 may be perpendicular to the main frame 11, e.g., perpendicular to the front-rear direction of the main frame 11. When the UAV 10 is hovering in the multi-rotor mode, the attitude of the UAV 10 is the attitude shown in FIG. 2. The front wings 12 and the rear wings 13 are perpendicular to the main frame 11, e.g., perpendicular to the front-rear direction of the main frame 11. The rotor power assemblies 14 and 16 rotate backward, and the rotor power assemblies 15 and 17 rotate forward. The rotor power assemblies 14-17 are maintained at an appropriate speed, such that rotation torques of the rotor power assemblies 14 and 16 and rotation torques of the rotor power assemblies 15 and 17 cancel out each other. Further, propelling forces of the plurality of rotor power assemblies 14-17 may offset the gravity of the UAV 10. Thus, the UAV 10 is maintained in a hovering state.

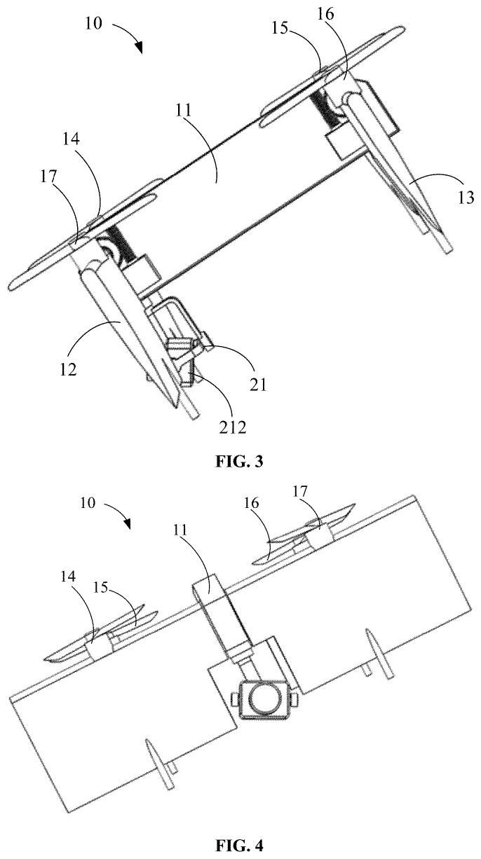

FIG. 3 illustrates a schematic diagram showing an attitude of the UAV 10 shown in FIG. 1 that flies forward in the multi-rotor mode according to some embodiments of the present disclosure. The front wings 12 and the rear wings 13 are perpendicular to the main frame 11, e.g., perpendicular to the front-rear direction of the main frame 11. The rotor power assemblies 14 and 16 rotate backward, and the rotor power assemblies 15 and 17 rotate forward. The front rotor power assemblies 14 and 17 decelerate, and the rear rotor power assemblies 15 and 16 accelerate, which causes the UAV 10 as a whole to tilt forward. The propelling forces of the plurality of rotor power assemblies 14-17 can overcome the gravity of the UAV 10 and generate a forward propelling force, such that the UAV 10 flies forward.

Similarly, the front rotor power assemblies 14 and 17 accelerate, and the rear rotor power assemblies 15 and 16 decelerate, and the propelling forces of the plurality of rotor power assemblies 14-17 can overcome the gravity of the UAV 10 and generate a backward propelling force, such that the UAV 10 flies backward.

FIG. 4 illustrates a schematic diagram showing an attitude of the UAV 10 shown in FIG. 1 that flies to the left and right in the multi-rotor mode according to some embodiments of the present disclosure. The front wings 12 and the rear wings 13 are perpendicular to the main frame 11, e.g., perpendicular to the front-rear direction of the main frame 11. The rotor power assemblies 14 and 16 rotate backward, and the rotor power assemblies 15 and 17 rotate forward. The rotor power assemblies 14 and 15 located at the right side of the main frame 11 accelerate. The rotor power assemblies 16 and 17 located at the left side of the main frame 11 decelerate. The propelling forces of the plurality of rotor power assemblies 14-17 can overcome the gravity of the UAV 10 and generate a propelling force to the left of the UAV 10. As such, the UAV 10 flies to the left.

Similarly, the rotor power assemblies 14 and 15 located at the right side of the main frame 11 decelerate. The rotor power assemblies 16 and 17 located at the left side of the main frame 11 accelerate. The propelling force of the plurality of rotor power assemblies 14-17 can overcome the gravity of the UAV 10 and generate a propelling force to the right of the UAV 10. As such, the UAV 10 flies to the right.

When the UAV 10 rotates in the multi-rotor mode, the rotor power assemblies 14 and 16 rotate backward, and the rotor power assemblies 15 and 17 rotate forward. The rotor power assemblies 14 and 16 accelerate, and the rotor power assemblies 15 and 17 decelerate. The UAV 10 as the whole has a forward rotation torque larger than the backward rotation torque, such that the UAV 10 as the whole rotates forward in the rotation plane of the rotor power assemblies 14-17.

Similarly, the rotor power assemblies 14 and 16 decelerate, and the rotor power assemblies 15 and 17 accelerate. The UAV 10 as the whole has a backward rotation torque larger than the forward rotation torque, such that the UAV 10 as the whole rotates backward in the rotation plane of the rotor power assemblies 14-17.

The UAV 10 may hover, fly forward, fly backward, fly to the left, fly to the right, rotate forward, and rotate backward in the multi-rotor mode. The UAV 10 can thus be operated flexibly.

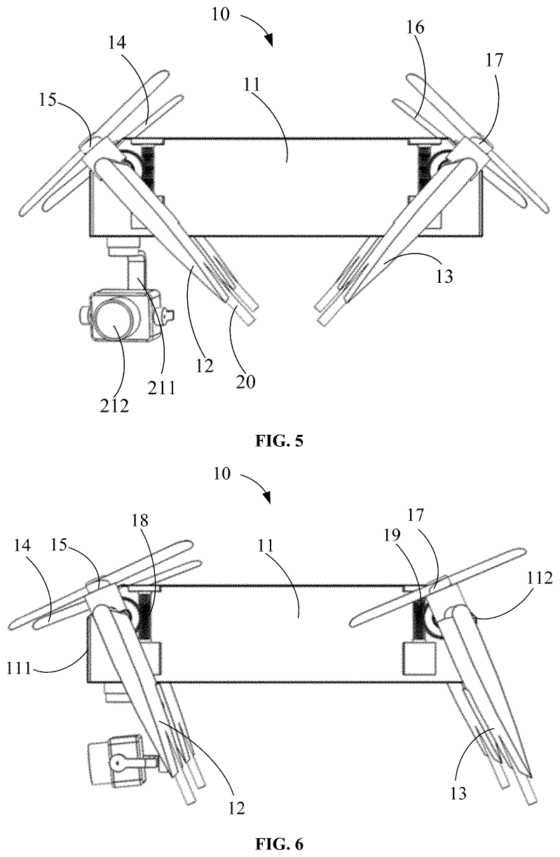

FIG. 5 illustrates a schematic diagram showing an attitude of the UAV 10 shown in FIG. 1 when increasing a shooting angle of a camera in the multi-rotor mode according to some embodiments of the present disclosure. When the UAV 10 flies in the multi-rotor mode, when the shooting angle of the camera 212 needs to be increased, the front wings 12 and the rear wings 13 tilt relative to the main frame 11 in opposite tilt directions. In FIG. 5, the lower parts of the front wings 12 tilt toward the back end of the main frame 11. The lower parts of the rear wings 13 tilt toward the front end of the main frame 11. The front wings 12 and the rear wings 13 have the same tilt angle relative to the main frame 11. The lower parts of the front wings 12 and stands 20 are away from the gimbal 211 and the camera 212. When the lens of the camera 212 rotates to the left side or the right side, the front wings 12 and the stands 20 do not block the lens, such that the shooting angle of the camera 212 is increased.

The UAV 10 may hover, fly forward, fly backward, fly to the left, or fly to the right under the attitude shown in FIG. 5. When the UAV 10 is hovering, the rotor power assemblies 14 and 16 rotate backward, and the rotor power assemblies 15 and 17 rotate forward. The front rotor power assemblies 14 and 17 generate a propelling force downward and generate a propelling force forward. The rotor power assemblies 15 and 16 generate a propelling force downward and generate a propelling force backward. The forward propelling force of the front rotor power assemblies 14 and 17 and the backward propelling force of the rear rotor power assemblies 15 and 16 cancels with each other out. The downward propelling forces of the plurality of rotor power assemblies 14-17 cancel the gravity of the UAV 10, such that the UAV 10 is maintained in the hovering state.

Similar to the UAV 10 under the attitude shown in FIG. 3, when the UAV 10 flies forward under the attitude shown in FIG. 5, the front rotor power assemblies 14 and 17 decelerate, and the rear rotor power assemblies 15 and 16 accelerate. When the UAV flies backward, the front rotor power assemblies 14 and 17 accelerate, and the rear rotor power assemblies 15 and 16 decelerate.

Similar to the UAV 10 in the attitude shown in FIG. 5, when the UAV 10 flies to the left under the attitude shown in FIG. 5, the rotor power assemblies 14 and 15 accelerate, and the rotor power assemblies 16 and 17 decelerate. When the UAV 10 flies to the right, the rotor power assemblies 14 and 15 decelerate, and the rotor power assemblies 16 and 17 accelerate.

FIG. 6 illustrates a schematic diagram showing an attitude of the UAV 10 shown in FIG. 1 in a high-speed flight mode according to some embodiments of the present disclosure. When the UAV 10 needs to fly at a high speed, the front wings 12 and the rear wings 13 tilt relative to the main frame 11 with the same tilt direction. The high speed means the speed is higher than the speed at which the UAV 10 flies in the multi-rotor mode. When the UAV 10 needs to fly at a low speed, the UAV 10 can fly in the multi-rotor mode shown in FIGS. 1-5. In FIG. 6, when the UAV 10 needs to fly forward at the high speed, the lower parts of the front wings 12 and the lower parts of the rear wings 13 all tilt toward the back end of the main frame 11. The front wings 12 and the rear wings 13 have the same tilt angle relative to the main frame 11.

When the UAV 10 needs to switch from the attitude of hovering to the attitude of flying forward at the high speed, the front wing drive assembly 18 drives the front wings 12 to tilt toward the front end of the main frame 11, that is the lower parts of the front wings 12 tilt toward the back end of the main frame 11, the rear wing drive assembly 19 drives the rear wings 13 to tilt toward the front end of the main frame 11, that is, the lower parts of the rear wings 13 tilt toward the back end of the main frame 11, and the rotation speeds of the plurality of rotor power assemblies 14-17 are increased at the same time. By tilting toward the front end of the main frame 11, the front wings 12 and the rear wings 13 may cause the rotor power assemblies 14-17 to generate a forward propelling force in the horizontal direction, such that the UAV 10 is propelled to fly forward. The increase in the rotation speeds of the plurality of rotor power assemblies 14-17 may compensate for the decrease of the propelling force in the vertical direction caused by the tilt toward the front end of the main frame 11 of the front wings 12 and the rear wings 13. Thus, the propelling force generated by the plurality of rotor power assemblies 14-17 may overcome the gravity and maintain the stability of the flight height.

When the tilt angle of the front wings 12 and the rear wings 13 and the rotation speeds of the rotor power assemblies 14-17 reach a certain degree, the wings 12 and 13 and the air form an effective angle-of-attack, the air can provide most of the lifting force, such that the UAV 10 can enter a high-speed flight mode. At this point, the plurality of rotor power assemblies 14-17 provide mainly the forward propelling force for the UAV 10. The lifting force formed by the front wings 12 and the rear wings 13 cutting the air is mainly used to overcome the gravity.

By turning the front wings 12 and the rear wings 13 and increasing the rotation speeds of the rotor power assemblies 14-17, the UAV 10 is switched from the multi-rotor mode to the high-speed flight mode. In some embodiments, by turning the front wings 12 and the rear wings 13 and reducing the rotation speeds of the rotor power assemblies 14-17, the UAV 10 is switched from the high-speed flight mode to the multi-rotor mode. As such, the UAV 10 may be conveniently switched between the multi-rotor mode and the high-speed flight mode, and the control scheme is simple.

The tilt angle of the font wings 12 and the rear wings 13 and/or the rotation speeds of the rotor power assemblies 14-17 may be changed to change the flight speed of the UAV 10. If the rotation speeds of the plurality of rotor power assemblies 14-17 remain unchanged, and the tilt angles of the front wings 12 and the rear wings 13 are reduced, the angles-of-attack of the front wings 12 and the rear wings 13 are increased. The height of the UAV 10 may be increased slightly due to inertia at first. However, after the angles-of-attack of the front wings 12 and the rear wings 13 are increased, a force component of the rotor power assemblies 14-17 are reduced at the horizontal direction, and flight resistance is increased. Therefore, the tilt angles of the front wings 12 and the rear wings 13 are reduced, such that the angle-of-attack of the front wings 12 and the rear wings 13 are increased, and the flight speed of the UAV 10 is reduced. Whether the flight height of the UAV 10 changes depends on a change of the lifting force, which is impacted by the combined effect of flight speed reduction and the angle-of-attack increment of the front wings 12 and the rear wings 13. If the lifting force is reduced, the flight height of the UAV 10 is reduced. If the lifting force is increased, the flight height of the UAV 10 is increased.

On the contrary, if the rotation speeds of the rotor power assemblies 14-17 remain unchanged and the tilt angles of the front wings 12 and the rear wings 13 are increased, the angles-of-attack of the front wings 12 and the rear wings 13 are reduced. The height of the UAV 10 is reduced due to the lifting force reduction. However, after the angles-of-attack of the front wings 12 and the rear wings 13 are reduced, the force component of the rotor power assemblies 14-17 is increased at the horizontal direction, and the flight resistance is reduced. Therefore, the tilt angles of the front wings 12 and the rear wings 13 are increased, such that the angles-of-attack of the front wings 12 and the rear wings 13 are reduced, and the flight speed of the UAV 10 is increased. Whether the flight height of the UAV 10 changes depends on the change of the lifting force, which is impacted by the combined effect of the flight speed increment of the UAV 10 and the angle-of-attack reduction of the front wings 12 and the rear wings 13.

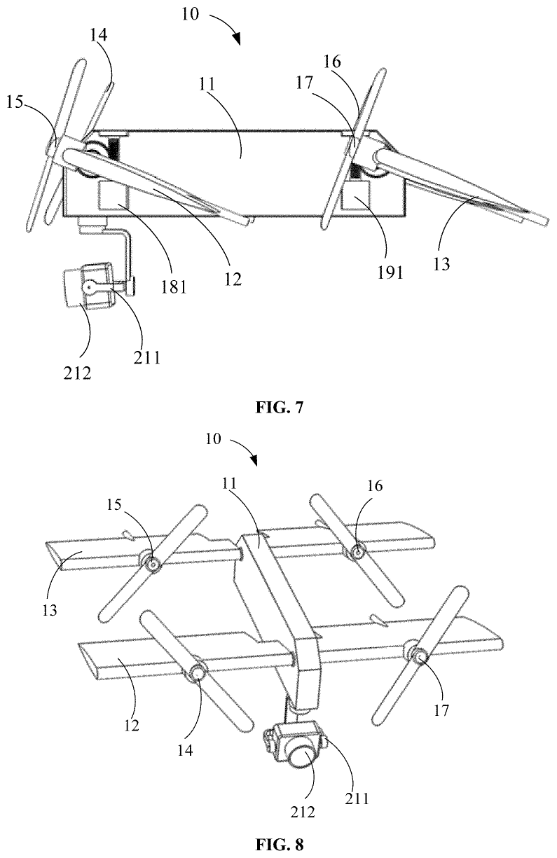

Compared with the attitude of the UAV 10 shown in FIG. 6, in FIG. 7 and FIG. 8, the tilt angles of the front wings 12 and the rear wings 13 of the UAV 10 are larger, and the angles-of-attack of the front wings 12 and the rear wings 13 are smaller. The power of the rotor electric motors is mainly used to propel the UAV 10 to fly forward, and the air resistance is smaller when the UAV 10 flies forward. When the rotation speeds of the rotor power assemblies 14-17 remain unchanged, the UAV 10 shown in FIG. 7 and FIG. 8 flies faster than the UAV 10 shown in FIG. 6. Therefore, the attitude of the UAV 10 in FIG. 7 and FIG. 8 can increase the flight speed of the UAV 10 and improve energy efficiency. As such, a high-speed, long-endurance flight may be realized.

When the UAV 10 flies at a constant speed in the high-speed flight mode, if the tilt angles of the front wings 12 and the rear wings 13 remain unchanged, and the rotation speeds of the plurality of rotor power assemblies 14-17 are increased, the forward propelling force of the UAV 10 may be increased. Therefore, the flight speed of the UAV 10 may be increased. The flight speed increment may cause the lifting force to increase, such that the flight height is increased. On the contrary, when the tilt angles of the front wings 12 and the rear wings 13 remain unchanged, the rotation speeds of the plurality of rotor power assemblies 14-17 are reduced, such that the flight speed and flight height of the UAV 10 are reduced.

In some embodiments, a flight control system (not shown in the figure) may collect flight status of the UAV 10 by using sensors (not shown in the figure) of the UAV 10, such as a barometer, an airspeed meter, a global positioning system (GPS), an inertial measurement unit (IMU), etc. The flight control system may control the tilt angles of the front wings 12 and the rear wings 13 and/or the rotation speeds of the rotor power assemblies 14-17 to control the flight speed and/or flight height of the UAV 10.

When the UAV 10 flies in the high-speed flight mode, as shown in FIG. 7 and FIG. 8, the stands 20 and the lower ends of the wings 12 and 13 are above the top of the camera 212, and the main frame 11 is maintained at a horizontal state. As such, the UAV 10 provides space to the gimbal 211 and the camera 212 in a large range to prevent the camera 212 from shooting the stands 20 and the front wings 12. The shooting angle of the camera 212 is thus effectively increased.

In the high-speed flight mode, when the flight direction needs to be controlled, the rotation speeds of the rotor power assemblies 14-17 at one side of the UAV 10 are increased, and at the same time, the rotation speeds of the rotor power assemblies 14-17 at the other side are reduced, such that the UAV 10 changes directions. For example, when the UAV 10 flies stably in the high-speed flight mode, increasing the rotation speeds of the rotor power assemblies 14 and 15 at the right side of the main frame 11 and decreasing the rotation speeds of the rotor power assemblies 16 and 17 at the left side of the main frame 11 can cause the UAV 10 to turn left. For another example, when the UAV 10 flies stably in the high-speed flight mode, decreasing the rotation speeds of the rotor power assemblies 14 and 15 at the right side of the main frame 11 and increasing the rotation speeds of the rotor power assemblies 16 and 17 at the left side of the main frame 11 can cause the UAV 10 to turn right. As such, the UAV 10 can be controlled to steer in the high-speed flight mode without a rudder, such that the body structure is simplified, and the weight is reduced.

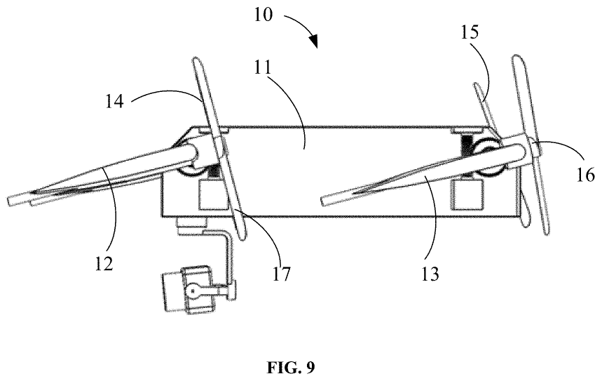

FIG. 9 illustrates a schematic diagram showing another attitude of the UAV 10 shown in FIG. 1 that flies backward in the high-speed flight mode according to some embodiments of the present disclosure. When the UAV 10 needs to fly backward at a high speed, the lower parts of the front wings 12 and the rear wings 13 all tilt toward the front end of the main frame. The front wings 12 and the rear wings 13 have the same tilt angle relative to the main frame 11. When the UAV 10 flies backward at the high speed, the control of the tilt angles of the front wings 12 and the rear wings 13, the rotation speeds of the rotor power assemblies 14-17, etc., is similar to the control when the UAV 10 flies forward, which is not repeated here. The UAV 10 turns the front wings 12 and the rear wings 13 to different positions such that the UAV 10 not only can fly forward at the high speed but also can fly backward at the high speed. The control is thus convenient and flexible.

The present disclosure also provides a UAV control method for controlling the UAV. The UAV includes the main frame, the pair of front wings, the pair of rear wings, and the plurality of rotor power assemblies. The pair of front wings are arranged at the two opposite sides of the main frame. The pair of rear wings are arranged at the two opposite sides of the main frame. The pair of rear wings are close to the rear end of the main frame relative to the pair of front wings. The plurality of rotor power assemblies are mounted at the front wings and the rear wings. The UAV control method includes controlling the front wings and the rear wings to turn in the front-rear direction relative to the main frame, and controlling the rotor power assemblies to rotate. The UAV control method may be used to control the above-described UAV 10. The UAV control method may simultaneously control the front wings and the rear wings to turn and the rotor power assemblies to rotate, or control the front wings and the rear wings to turn first and then control the rotor power assemblies to rotate or control the rotor power assemblies to rotate first and then control the front wings and the rear wings to turn. The UAV control method may control rotation directions and/or angles of the front wings and the rear wings, and control rotation directions and/or rotation speeds of the rotor power assemblies.

When the UAV takes off and lands, the UAV control method includes controlling the front wings and the rear wings to be perpendicular to the main frame, e.g., perpendicular to the front-rear direction of the main frame, and controlling the rotation speeds of the rotor power assemblies to cause the UAV to take off or land.

When the UAV flies in the multi-rotor mode, the UAV control method includes controlling the front wings and the rear wings to be perpendicular to the main frame, e.g., perpendicular to the front-rear direction of the main frame. When the front wings and the rear wings are perpendicular to the main frame, e.g., perpendicular to the front-rear direction of the main frame, the UAV control method may include controlling the UAV to hover, fly forward, fly backward, fly to the left, fly to the right, rotate forward, or rotate backward in the multi-rotor mode.

In some embodiments, the UAV includes a gimbal mounted at the main frame and a camera mounted at the gimbal. When the UAV flies in the multi-rotor mode, and the shooting angle needs to be increased, the UAV control method may include controlling the front wings and the rear wings to tilt relative to the main frame in the opposite directions. In some embodiments, the UAV control method may include controlling the lower parts of the front wings to tilt toward the back end of the main frame and the lower parts of the rear wings to tilt toward the front end of the main frame, such that the lower parts of the wings are away from the camera to avoid the front wings and the stands arranged at the lower parts of the front wings from blocking the camera, so as to increase the shooting angle of the camera. The UAV control method may include controlling the rotations of the rotor power assemblies to cause the UAV to hover, fly forward, fly backward, fly to the left, or fly to the right.

When the UAV needs to fly at the high speed, the UAV control method includes controlling the front wings and the rear wings to tilt relative to the main frame with the same tilt direction and controlling the front wings and the rear wings to have the same tilt angle relative to the main frame. When the UAV needs to fly forward at a high speed, the UAV control method includes controlling the lower parts of the front wings and the lower parts of the rear wings to tilt toward the back end of the main frame. When the UAV needs to fly backward at a high speed, the UAV control method includes controlling the lower parts of the front wings and the lower parts of the rear wings to tilt toward the front end of the main frame. When the rotation speeds of the rotor power assemblies do not change, the UAV control method may include changing the tilt angles of the front wings and the rear wings relative to the main frame to change the flight speed of the UAV. When the tilt angles of the front wings and the rear wings relative to the main frame do not change, the UAV control method may include changing the rotation speeds of the plurality of rotor power assemblies to change the flight speed of the UAV. The UAV control method may also include changing the tilt angles of the front wings and the rear wings relative to the main frame and the rotation speeds of the plurality of rotor power assemblies simultaneously to change the flight speed of the UAV, or changing the tilt angles of the front wings and the rear wings relative to the main frame and/or the rotation speeds of the plurality of rotor power assemblies to change the flight height of the UAV.

When the tilt angles of the front wings and the rear wings relative to the main frame do not change, the UAV control method may include controlling the rotation speeds of the rotor power assemblies at the other side of the main frame and the rotation speeds of the rotor power assemblies at one side of the main frame to be different to change the flight direction of the UAV, such that the UAV may turn to the side with lower rotation speeds of the rotor power assemblies.

Since method embodiments correspond to device embodiments, related parts may be made referred to a partial description of the device embodiments. The method embodiments and the device embodiments complement each other.

Relational terms such as “first” and “second” are only used to distinguish one entity or operation from another entity or operation and do not necessarily require or imply that there is any such actual relationship or order between these entities or operations. The terms of “include,” “contain,” or any other variant thereof are intended to cover non-exclusive inclusion, so that a process, method, article, or device that includes a series of elements includes not only those elements, but also other elements that are not explicitly listed, or also include elements inherent to such process, method, article, or device. Without more restrictions, the element defined by the sentence “include one . . .” does not exclude that there are other identical elements in the process, method, article, or device that includes the element.

The methods and devices provided by embodiments of the present disclosure are described in detail above. Specific examples are used to explain the principles and implementations of the present disclosure. The above-described embodiments are only used to help understand the method and the core ideas of the present disclosure. For those of ordinary skill in the art, according to the ideas of the present disclosure, modifications exist in the specific implementations and their application scope. Therefore, the content of the present specification should not be understood to limit the present disclosure.

What is claimed is:

1. An unmanned aerial vehicle (UAV) comprising:
a main frame;
a pair of front wings arranged at two opposite sides of the main frame and configured to rotate relative to the main frame about a first rotation axis perpendicular to a front-rear direction of the main frame;
a pair of rear wings arranged at the two opposite sides of the main frame and being closer to a rear end of the main frame than the pair of front wings, the pair of rear wings being configured to rotate relative to the main frame about a second rotation axis perpendicular to the front-rear direction of the main frame; and
a plurality of rotor power assemblies mounted at the front wings and the rear wings.

2. The UAV of claim 1, further comprising:
a front wing drive assembly arranged at the main frame and connected to the front wings, the front wing drive assembly being configured to drive the front wings to rotate; and
a rear wing drive assembly arranged at the main frame and connected to the rear wings, the rear wing drive assembly being configured to drive the rear wings to rotate.

3. The UAV of claim 2, wherein:
the front drive assembly includes a front electric motor, a front screw connected to the front electric motor, and a front gear meshed with the front screw, the front gear being connected to the front wings; and
the rear drive assembly includes a rear electric motor, a rear screw connected to the rear electric motor, a rear gear meshed with the rear screw, the rear gear being connected to the rear wings.

4. The UAV of claim 2, wherein each of the front wing drive assembly and the rear wing drive assembly includes two electric motors rotating in opposite directions.

5. The UAV of claim 1, wherein the plurality of rotor power assemblies include:
a pair of front rotor power assemblies mounted at the pair of front wings symmetrically about the main frame; and
a pair of rear rotor power assemblies mounted at the pair of rear wings symmetrically about the main frame.

6. The UAV of claim 5, wherein each of the front rotor power assemblies is mounted at a center position of an upper side edge of one of the front wings, and each of the rear rotor power assemblies is mounted at a center position of an upper side edge of one of the rear wings.

7. The UAV of claim 5, wherein a distance from one of the front rotor power assemblies to the main frame is equal to a distance from one of the rear rotor power assemblies to the main frame.

8. The UAV of claim 5, wherein rotation planes of the rotor power assemblies are perpendicular to the front wings and the rear wings.

9. The UAV of claim 1, further comprising:
a plurality of stands each arranged at a lower part of one of the front wings and the rear wings and extending downward beyond a lower side edge of the one of the front wings and the rear wings.

10. The UAV of claim 1, wherein the front wings and the rear wings are configured to be perpendicular to the front-rear direction of the main frame when the UAV takes off or lands.

11. The UAV of claim 1, wherein the front wings and the rear wings are configured to be perpendicular to the front-rear direction of the main frame when the UAV flies in a multi-rotor mode.

12. The UAV of claim 11, further comprising:
a load mounted at a front end of the main frame and located between the pair of front wings.

13. The UAV of claim 12, wherein the load includes a gimbal mounted at the main frame and a camera mounted at the gimbal.

14. The UAV of claim 13, wherein an opening is formed between lower parts of the pair of front wings, and the gimbal is in the opening.

15. The UAV of claim 13, wherein the front wings and the rear wings are configured to tilt relative to the main frame in opposite tilt directions to allow the camera to have a larger shooting angle when the UAV flies in the multi-rotor mode.

16. The UAV of claim 15, wherein lower parts of the front wings are configured to tilt backward relative to the main frame, and lower parts of the rear wings are configured to tilt forward relative to the main frame.

17. The UAV of claim 1, wherein the front wings and the rear wings are configured to tilt relative to the main frame in a same tilt direction when the UAV flies in a high-speed mode.

18. The UAV of claim 17, wherein the front wings and the rear wings are configured to tilt at a same tilt angle relative to the main frame in the high-speed mode.

19. The UAV of claim 17, wherein lower parts of the front wings and lower parts of the rear wings tilt backward in the high-speed mode to effect a forward high-speed flight.

20. The UAV of claim 17, wherein lower parts of the front wings and lower parts of the rear wings tilt forward in the high-speed mode to effect a backward high-speed flight.
